(19) United States
(12) Patent Application Publication
(10) Pub. No.: US 2018/0363709 A1
(43) Pub. Date: Dec. 20, 2018

(54) DETACHABLE SLAT ANGLE ADJUSTMENT MECHANISM

(71) Applicant: SHEEN WORLD TECHNOLOGY CORPORATION, TAICHUNG CITY (TW)

(72) Inventor: Po-Yu CHEN, TAICHUNG CITY (TW)

(21) Appl. No.: 15/871,331

(22) Filed: Jan. 15, 2018

(30) Foreign Application Priority Data
Jun. 20, 2017 (TW) 106120628

(51) Int. Cl. F16D 1/108; E06B 9/322; F16H 1/16

(52) U.S. Cl. CPC F16D 1/108; F16H 1/16; E06B 9/322

(57) ABSTRACT

A detachable slat angle adjustment mechanism includes a casing, a worm wheel rotatably mounted in the casing, and a worm shaft set including a first shaft member and second shaft member. The first shaft member is rotatably mounted in the casing and includes a worm meshed with the worm wheel and a coupling portion with an axle hole axially defined therein and two opposing positioning hole connected to the axle hole. The second shaft member has a mounting axle axially extended from a top end thereof and detachably insertable into the axle hole of the first shaft member, two positioning protrusions respectively protruded from the outer perimeter of the mounting axle and detachably engageable into the respective positioning holes of the first shaft member, and an opposing bottom end that suspends outside the casing after connection of the mounting axle to the axle hole of the first shaft member.

### BACKGROUND OF THE INVENTION

### 1. Field of the Invention

The present invention relates to window blind technology, and more particularly to a detachable slat angle adjustment mechanism for window blind.

### 2. Description of the Related Art

A conventional slat angle adjustment mechanism for adjusting the angle of the slats of a window blind generally comprises a casing, a worm wheel, and a worm shaft. The casing is mounted in the top rail of the window blind. The worm wheel is rotatably mounted in the casing. The worm shaft has a worm located at one end thereof and inserted into the inside of the casing and meshed with the worm wheel, and an opposite end thereof extended out of the casing and suspended outside the top rail for the hooking of a rotary handle that is biasable by the user to rotate the worn shaft and the worm wheel, causing a connected transmission member to bias the slats of the window blind.

However, as the worm shaft and the worm wheel have been installed in the casing in the factory, they do not allow the consumer to assemble the slat angle adjustment mechanism after purchase, so the worm shaft is exposed to the outside of one end of the top rail of the window blind. The protruded worm shaft can easily be damaged or can damage the slats of the window blind accidentally during packaging or delivery. An improvement in this regard is desired.

### SUMMARY OF THE INVENTION

The present invention has been accomplished under the circumstances in view. It is the main object of the present to provide a detachable slat angle adjustment mechanism for window blind, which can be assembled by the consumer, avoiding accidental damage of the worm shaft set and prohibiting the worm shaft set from damaging the slats of the window blind during packaging or delivery.

To achieve this and other objects of the present invention, a detachable slat angle adjustment mechanism comprises a casing, a worm and a worm shaft set. The worm wheel is rotatably mounted in the casing. The worm shaft set comprises a first shaft member and a second shaft member. The first shaft member is rotatably mounted in the casing, comprising a worm and a coupling portion. The worm is meshed with the worm wheel. The coupling portion is integrally connected with one end of the worm, comprising an axle hole and two opposing positioning hole. The axle hole extends in a parallel manner relative to the axis of the worm. The two positioning holes are radially connected to the axle hole. The second shaft member comprises a mounting axle axially extended from a top end thereof and detachably insertable into the axle hole in the coupling portion of the first shaft member, and two positioning protrusions respectively protruded from an outer perimeter of the mounting axle and detachably engageable into the respective positioning holes of the first shaft member. Further, the second shaft member has an opposing bottom end that suspends outside the casing after connection of the mounting axle to the axle hole of the first shaft member. Thus, the first and second shaft members are detachably mountable by the consumer, avoiding accidental damage of the worm shaft set and prohibiting the worm shaft set from damaging the slats of the window blind during packaging or delivery.

Preferably, the axle hole and said mounting axle are respectively configured to provide a non-circular cross section. By means of coupling between the non-circular axle hole and the non-circular mounting axle, the first shaft member and the second shaft member are prohibited from rotation relative to each other.

Preferably, the second shaft member further comprises a hook hole located in an opposing bottom end thereof for the hooking of a rotary handle that is biasable to rotate the worm shaft set.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 illustrates the outer appearance of a detachable slat angle adjustment mechanism for window blind in accordance with the present invention.

FIG. 2 is an exploded view of the detachable slat angle adjustment mechanism in accordance with the present invention.

FIG. 3 is a sectional view of the detachable slat angle adjustment mechanism in accordance with the present invention.

FIG. 4 is a top view of the second shaft member of the detachable slat angle adjustment mechanism in accordance with the present invention.

FIG. 5 is a bottom view of the first shaft member of the detachable slat angle adjustment mechanism in accordance with the present invention.

### DETAILED DESCRIPTION OF THE INVENTION

The present invention will now be described in detail with reference to the accompanying drawings, in which the directional terms of “top”, “bottom”, “left”, “right”, “inside”, “outside” are terms of benchmark description in the normal use but not intended for use to limit the scope of the intention.

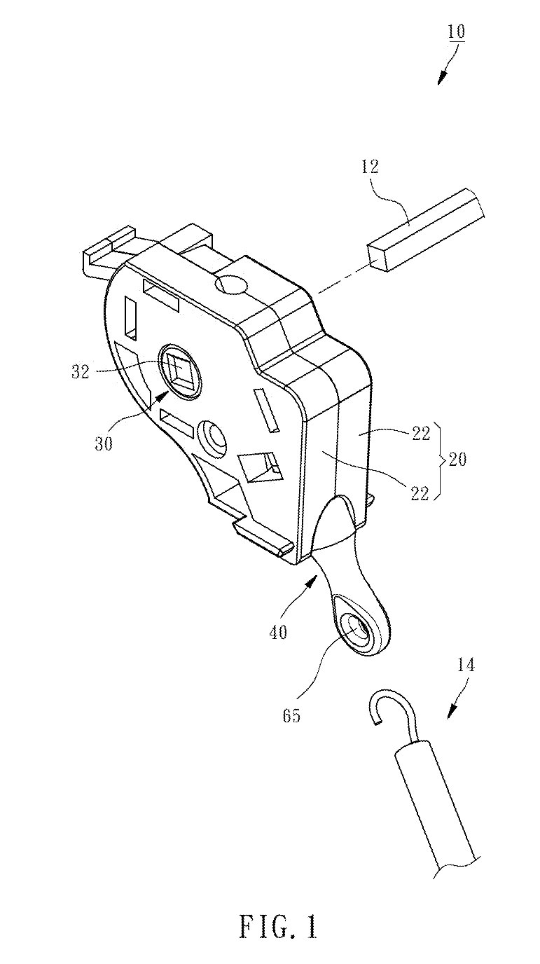

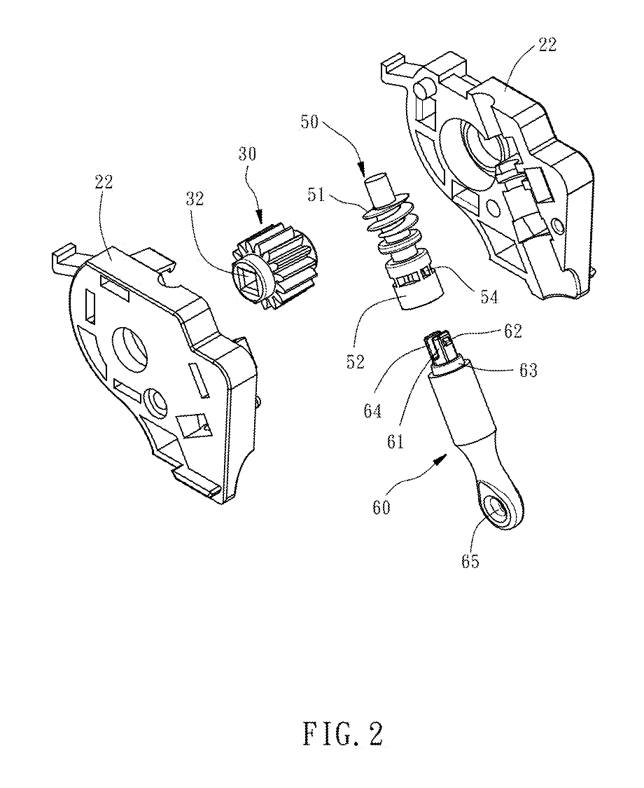

Referring to FIG. 1 and FIG. 2, a detachable slat angle adjustment mechanism 10 in accordance with the present invention is shown. The detachable slat angle adjustment mechanism 10 comprises a casing 20, a worm wheel 30, and a worm shaft set 40.

The casing 20 comprises two half shells 22 fastened together, a first mounting through hole 24 horizontally cutting through opposing left and right sides of the two half shells 22, and a second mounting through hole 26 obliquely cutting through opposing top and bottom sides of the two half shells 22.

The worm wheel 30 is rotatably mounted in the first mounting through hole 24 of the casing 20, comprising a rectangular coupling hole 32 for the mounting of a driving shaft 12 that can be driven to rotate the worm wheel 30 synchronously.

The worm shaft set 40 comprises a first shaft member 50 and a second shaft member 60.

The first shaft member 50 is rotatably mounted in the second mounting through hole 26 of the casing 20, comprising a worm 51, and a coupling portion 52. The worm 51 is meshed with the worm wheel 30. The coupling portion 52 is formed integral with one end of the worm 51, comprising an axle hole 53, two opposing positioning holes 54 and a coupling groove 55. The axle hole 53 extends axially from a distal end of the coupling portion 52 toward the worm 51 in a parallel manner relative to the axis of the worm 51. The positioning holes 54 extend perpendicular to the extending direction of the axle hole 53, each having one end thereof connected to the axle hole 53 and an opposite end thereof forming an opening on the outer perimeter of the coupling portion 52. The coupling groove 55 is located on the distal end of the coupling portion 52 and disposed in communication with the axle hole 53. The coupling groove 55 is configured to provide a circular cross section

The second shaft member 60 is rotatably mounted in the second mounting through hole 26 of the casing 20, comprising a mounting axle 61 axially extended from one end thereof, a slit 64 axially formed in the mounting axle 61 to make the mounting axle 61 elastically deformable, two positioning protrusions 62 radially protruded from the periphery of the mounting axle 61 at two opposite sides, a coupling flange 63 extended around the periphery thereof and abutted to a bottom end of the mounting axle 61, and a hook hole 65 located in an opposite end thereof for the hooking of a rotary handle 14. The coupling flange 63 is configured to provide a circular cross section.

When assembling the first shaft member 50 and the second shaft member 60, insert the mounting axle 61 of the second shaft member 60 into the axle hole 53 of the first shaft member 50 to force the positioning protrusions 62 into engagement with the respective positioning holes 54 in the coupling portion 52 of the first shaft member 50 and to further prohibit separation between the first shaft member 50 and the second shaft member 60. At this time, the coupling flange 63 is press-fitted into the coupling groove 55. Thus, the user can hook the rotary handle 14 in the hook hole 65 of the second shaft member 60 and then bias the rotary handle 14 to rotate the second shaft member 60 and the first shaft member 50. During rotation of the first shaft member 50, the worm 51 is driven to rotate the worm wheel 30 and the connected driving shaft 12, causing rotation of the coupled transmission component parts (not shown) and adjustment of the angular position of the slats of the window blind (not shown).

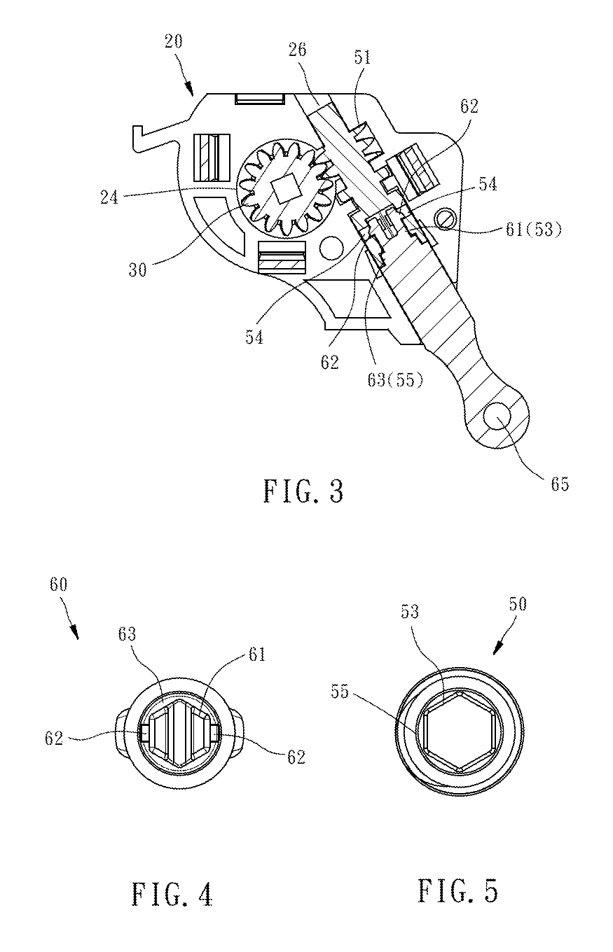

In order to prohibit relative rotary motion between the first shaft member 50 and the second shaft member 60 after installation, as illustrated in FIGS. 3-5, the axle hole 53 of the first shaft member 50 and the mounting axle 61 of the second shaft member 60 are respectively configured to provide a non-circular profile. In the present preferred embodiment, the axle hole 53 of the first shaft member 50 and the mounting axle 61 of the second shaft member 60 are configured to provide a hexagonal cross section. However, this hexagonal cross section is not a limitation, other polygonal cross section can be selectively adopted.

As described above, the worm wheel 30 and the first shaft member 50 are mounted inside the casing 20 and kept from sight; the second shaft member 60 is a detachable component detachably connectable to the first shaft member 50. In other words, the second shaft member 60 is neither connected to the first shaft member 50 nor extended out of the casing 20 and the top rail of the window blind during packaging and delivery. This design not only can avoid the second shaft member 60 from being damaged and broken by improper external force, but also prohibit the second shaft member 60 from damaging or deforming the slats of the window blind accidentally.

What is claimed is:

1. A detachable slat angle adjustment mechanism, comprising:
a casing;
a worm wheel rotatably mounted in said casing; and
a worm shaft set comprising a first shaft member and a second shaft member, said first shaft member being rotatably mounted in said casing and comprising a worm and a coupling portion, said worm being meshed with said worm wheel, said coupling portion being integrally connected with one end of said worm and comprising an axle hole and two opposing positioning hole, said axle hole extending in a parallel manner relative to the axis of said worm, said two positioning holes being radially connected to said axle hole, said second shaft member comprising a mounting axle axially extended from a top end thereof and detachably insertable into said axle hole in said coupling portion of said first shaft member, two positioning protrusions respectively protruded from an outer perimeter of said mounting axle and detachably engageable into the respective said positioning holes of said first shaft member, said second shaft member having an opposing bottom end that suspends outside said casing after connection of said mounting axle to said axle hole of said first shaft member.

2. The detachable slat angle adjustment mechanism as claimed in claim 1, wherein said axle hole and said mounting axle are respectively configured to provide a non-circular cross section.

3. The detachable slat angle adjustment mechanism as claimed in claim 2, wherein said axle hole and said mounting axle are respectively configured to provide a hexagonal cross section.

4. The detachable slat angle adjustment mechanism as claimed in claim 1, wherein said first shaft member further comprises a coupling groove located on one end of said coupling portion and abutted to and in communication with said axle hole; said second shaft member further comprises a coupling flange abutted to one end of said mounting axle and detachably engageable in said coupling groove of said first shaft member.

5. The detachable slat angle adjustment mechanism as claimed in claim 4, wherein said coupling groove and said coupling flange are respectively configured to provide a circular cross section.

6. The detachable slat angle adjustment mechanism as claimed in claim 1, wherein said second shaft member further comprises a hook hole located in an opposing bottom end thereof.
